(19) United States
(12) Patent Application Publication
(10) Pub. No.: US 2025/0281946 A1
(43) Pub. Date: Sep. 11, 2025

(54) METHOD FOR CLEANING A STEAMING SYSTEM, STEAMING SYSTEM FOR A COOKING APPLIANCE AND COOKING APPLIANCE COMPRISING A COOKING CHAMBER

(71) Applicant: Miele & Cie. KG, Gütersloh (DE)

(72) Inventors: Martin KINZEL, Ennigerloh (DE); Joachim RENDER, Warendorf (DE); Eugen KULEMIN, Beckum (DE); Torben BECKER, Bielefeld (DE)

(21) Appl. No.: 19/071,795

(22) Filed: Mar. 6, 2025

(30) Foreign Application Priority Data
Mar. 7, 2024 (DE) 10 2024 106 522.2

(51) Int. Cl. B08B 3/08; A47J 27/04; B08B 9/08; F24C 15/32

(52) U.S. Cl. CPC B08B 3/08; A47J 27/04; B08B 9/08; F24C 15/327; A47J 2027/043; B08B 2203/007; B08B 2203/027; B08B 2209/08

(57) ABSTRACT

A method for cleaning a steaming system of a cooking appliance having a cooking chamber, includes, in order: filling a tank of the steaming system with a cleaning acid by a filling pipe and a pump of the steaming system until the cleaning acid overflows from the tank into the cooking chamber by an overflow pipe of the steaming system, which overflow pipe comprises a shut-off valve; circulating the cleaning acid from the tank into a steam generator of the steaming system and back; filling the tank with fresh water by the filling pipe and the pump, with the shut-off valve closed and the steam generator switched off, until the cleaning acid is displaced into the cooking chamber by the fresh water in a bypass pipe fluidically connected to the steam generator and the overflow pipe; and filling the tank with air by the filling pipe and the pump.

### CROSS-REFERENCE TO PRIOR APPLICATION

Priority is claimed to German Patent Application No. DE 10 2024 106 522.2, filed on Mar. 7, 2024, the entire disclosure of which is hereby incorporated by reference herein.

### FIELD

The invention relates to a method for cleaning a steaming system of a cooking appliance comprising a cooking chamber, to a steaming system and to a cooking appliance comprising a cooking chamber.

### BACKGROUND

Such methods, steaming systems and cooking appliances are already known from the prior art in a variety of embodiments, for example from the publications DE 10 2007 048 567 A1 and DE 10 2019 125 135 A1 and US 2020/0 191 404 A1.

### SUMMARY

In an embodiment, the present invention provides a method for cleaning a steaming system of a cooking appliance having a cooking chamber, the method comprising, in order: filling a tank of the steaming system with a cleaning acid by a filling pipe and a pump of the steaming system until the cleaning acid overflows from the tank into the cooking chamber by an overflow pipe of the steaming system, which overflow pipe comprises a shut-off valve; circulating the cleaning acid from the tank into a steam generator of the steaming system and back; filling the tank with fresh water by the filling pipe and the pump, with the shut-off valve closed and the steam generator switched off, until the cleaning acid is displaced into the cooking chamber by the fresh water in a bypass pipe fluidically connected to the steam generator and the overflow pipe; filling the tank with air by the filling pipe and the pump, with the shut-off valve closed, until the fresh water is displaced into the cooking chamber by the bypass pipe; wetting the pump with a predetermined amount of fresh water by the filling pipe and the pump, the predetermined amount of fresh water being designed only to wet the pump; and evaporating an amount of residual water downstream of the pump in the steaming system by the steam generator, with the shut-off valve open.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows, in a method diagram, an embodiment of the cooking appliance according to the invention comprising the steaming system according to the invention for carrying out the method according to the invention,

FIGS. 2 to 7 show the embodiment, in each case in a representation analogous to FIG. 1, during the individual method steps.

### DETAILED DESCRIPTION

The invention therefore addresses the problem of improving a method for cleaning a steaming system of a cooking appliance comprising a cooking chamber, a steaming system and a cooking appliance comprising a cooking chamber.

In an embodiment, the present invention provides an improved method for cleaning a steaming system of a cooking appliance comprising a cooking chamber, steaming system and cooking appliance comprising a cooking chamber. Due to the design of the method, the steaming system and the cooking appliance according to the invention, cleaning a steaming system of a cooking appliance comprising a cooking chamber is significantly improved in a very simple manner in terms of construction, manufacturing technology and circuitry. Furthermore, the steaming system according to the invention and thus the cooking appliance according to the invention can be operated reliably by means of the method according to the invention even over a long service life of the cooking appliance according to the invention. In conventional methods, steaming systems and cooking appliances comprising cooking chambers, the usual pumping out or draining of the saturated cleaning acid is fundamentally critical due to solid suspended particles in the cleaning acid. This applies in particular to structurally small steaming systems. This often leads to leaks from valves and damage to pumps. The invention provides a remedy for this. Furthermore, the invention provides a corresponding method and steaming system in which an additional pump for pumping out the saturated cleaning acid and an additional drain into the cooking chamber for discharging the saturated cleaning acid from the steaming system can be omitted. In addition, the invention is suitable for significantly extending the life, i.e. the total operating period, of the individual components of the steaming system. This is because, on the one hand, the only pump of the steaming system according to the invention exclusively conveys pure cleaning acid, i.e. cleaning acid without solid particles, pure fresh water and pure air, and, on the other hand, the only shut-off valve is only activated for a short time after prior wetting with liquid.

The term ‘cleaning’ is to be interpreted broadly here and includes in particular the descaling of the steaming system according to the invention.

In principle, the method according to the invention, the steaming system according to the invention and the cooking appliance according to the invention can be freely selected within a broad suitable range. For example, the cooking appliance according to the invention can be a household appliance or a professional appliance, i.e. a cooking appliance for commercial use.

In an advantageous development of the method according to the invention, the cleaning acid is citric acid and/or the fresh water is tap water and/or the air is ambient air. On the one hand, this cleaning acid is thus a cleaning acid which is very suitable for successful cleaning, especially for descaling. Furthermore, citric acid can be used safely in cooking appliances comprising a cooking chamber for cooking food. On the other hand, fresh water in the form of tap water and air in the form of ambient air are readily available in situ.

In an additional advantageous development of the method according to the invention, the circulation of the cleaning acid takes place only by means of the steam generator, preferably the steam generator is operated in short heating pulses such that a thermal circulation of the cleaning acid takes place. As a result, the steaming system according to the invention can be implemented in a particularly simple manner in terms of construction, manufacturing technology and circuitry. This applies in particular to the preferred embodiment of this development.

To wet the pump with fresh water, a small amount of fresh water is required, just enough to keep the inner surface of the pump moist. In the present invention, the term ‘to wet’ or ‘wetting’ is understood as ‘to make wet, to moisten’.

In another advantageous development of the method according to the invention, the predetermined amount of fresh water for wetting the pump is less than or equal to 50 ml, preferably less than or equal to 40 ml, particularly preferably less than or equal to 30 ml. In this manner, the amount of fresh water supplied to the steaming system according to the invention in this specific method step of the method according to the invention is limited to a minimum, without thereby impairing the function of the method according to the invention and the longevity of the steaming system according to the invention.

As already indicated above, the type, mode of operation, material and dimensions of the steaming system according to the invention can be freely selected within a broad suitable range. The steaming system expediently comprises the following components in the specified arrangement: a tank, a filling pipe fluidically connected to the tank and comprising a pump for filling the tank with a fluid, a steam generator fluidically connected to the tank by means of a connecting pipe, an overflow pipe comprising a shut-off valve for fluidically connecting the tank to the cooking chamber, and a bypass pipe fluidically connected to the tank, the steam generator and the overflow pipe, which bypass pipe is intended for fluidically connecting to the cooking chamber of the cooking appliance.

In an advantageous development of the aforementioned embodiment of the steaming system according to the invention, the filling pipe comprising the pump is fluidically connected to the tank on an upper side of the tank and/or the steam generator is fluidically connected to the tank, at one end at a position on one side of the tank directly adjacent to the upper side and at the other end on a lower side of the tank and/or the overflow pipe is fluidically connected to the tank on the upper side of the tank and/or the bypass pipe is fluidically connected to the tank on the lower side. As a result, the individual fluidic connections between the individual components of the steaming system according to the invention are realized in a particularly functional manner.

In an additional advantageous development of the steaming system, the shut-off valve is designed as a pinch valve. Due to the lack of moving parts that come into contact with the cleaning acid, for example, pinch valves are very wear-resistant and therefore require little maintenance. Accordingly, operating costs are reduced and the service life of the shut-off valve, i.e. its lifespan, is extended. In principle, however, other types and modes of operations of valves for the shut-off valve are also conceivable.

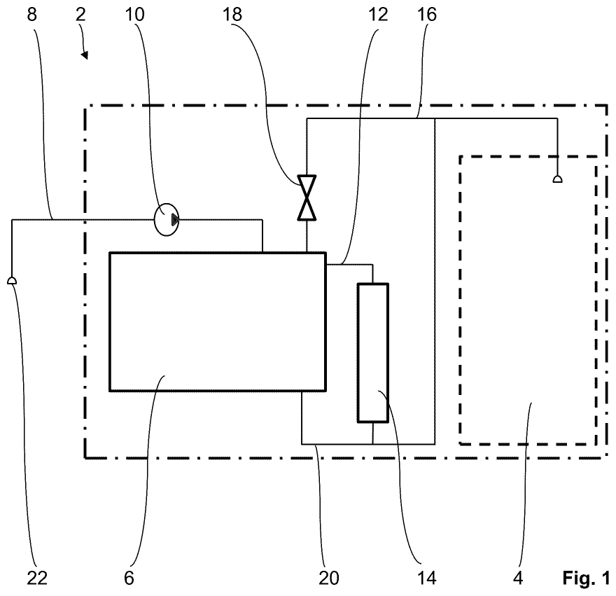

FIGS. 1 to 7 show a purely exemplary embodiment of the cooking appliance according to the invention, comprising the steaming system according to the invention for carrying out the method according to the invention.

The steaming system 2 for a cooking appliance designed as a household steam cooker comprising a cooking chamber 4 comprises a tank 6, a filling pipe 8 fluidically connected to the tank 6 and comprising a pump 10 for filling the tank 6 with a fluid, a steam generator 14 fluidically connected to the tank 6 by means of a connecting pipe 12, an overflow pipe 16 comprising a shut-off valve 18 for fluidically connecting the tank 6 to the cooking chamber 4, and a bypass pipe 20 fluidically connected to the tank 6, the steam generator 14 and the overflow pipe 16, which bypass pipe is intended for fluidically connecting to the cooking chamber 4 of the cooking appliance. The cooking appliance is indicated in FIGS. 1 to 7 by a dash-dotted line. The cooking chamber 4 shown in FIGS. 1 to 7 by a dashed line does not belong to the steaming system 2 in the strict sense.

As can also be seen from FIGS. 1 to 7, the filling pipe 8 comprising the pump 10 is fluidically connected to the tank 6 on an upper side of the tank 6, the steam generator 14 is fluidically connected to the tank 6, at one end at a position on one side of the tank 6 directly adjacent to the upper side and at the other end on a lower side of the tank 6, the overflow pipe 16 fluidically is connected to the tank 6 on the upper side of the tank 6, and the bypass pipe 20 is fluidically connected to the tank 6 on the lower side. In the present embodiment, the shut-off valve 18 is designed as a pinch valve.

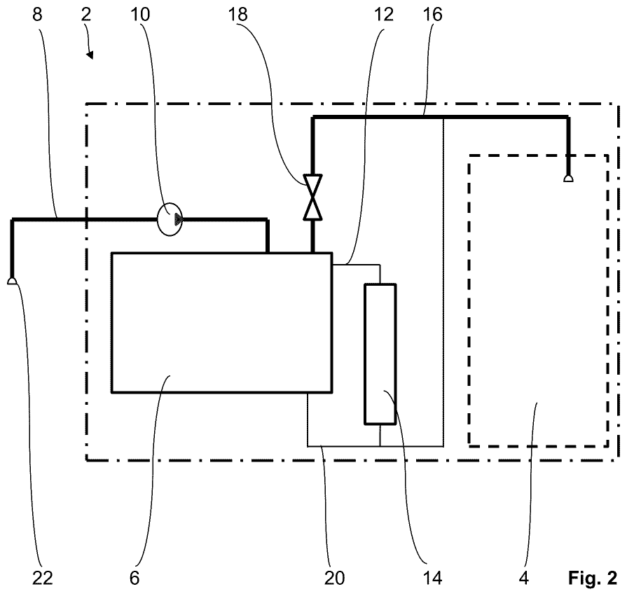

In the following, the method according to the invention and the mode of operation of the cooking appliance according to the invention comprising the steaming system according to the invention are explained in more detail in accordance with the present embodiment, with reference to FIGS. 1 to 7. Fluidic connections through which a fluid flows in the relevant method step are symbolized by a thick solid line in FIGS. 2 to 7.

In a first method step, the tank 6 of the steaming system 2 is filled with a cleaning acid, namely citric acid, by means of the filling pipe 6 and the pump 8 of the steaming system 2 until the cleaning acid overflows from the tank 2 into the cooking chamber 4 by means of the overflow pipe 16 of the steaming system 2, which overflow pipe has the shut-off valve 18. For this, see FIG. 2. The shut-off valve 18 is open in this case. For the purpose of the aforementioned filling of the tank 6 with the cleaning acid, the filling pipe 8 has a filler neck 22 upstream of the pump 10, namely at the free end of the filling pipe. For example, the filler neck 22 can be immersed in a vessel filled with the cleaning acid so that the pump 10 can suck the cleaning acid out of the vessel.

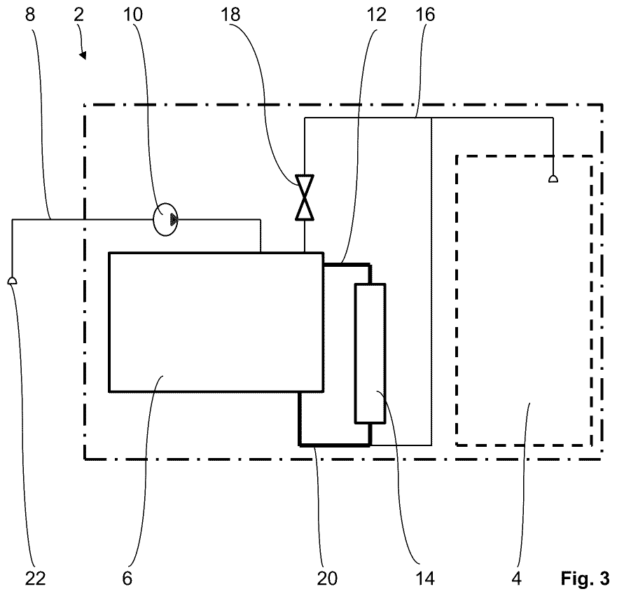

In a second method step shown in FIG. 3, the cleaning acid is circulated from the tank 6 into the steam generator 14 of the steaming system 2 and back. The circulation of the cleaning acid takes place here only by means of the steam generator 14, namely such that the steam generator 14 is operated in short heating pulses, so that a thermal circulation of the cleaning acid takes place.

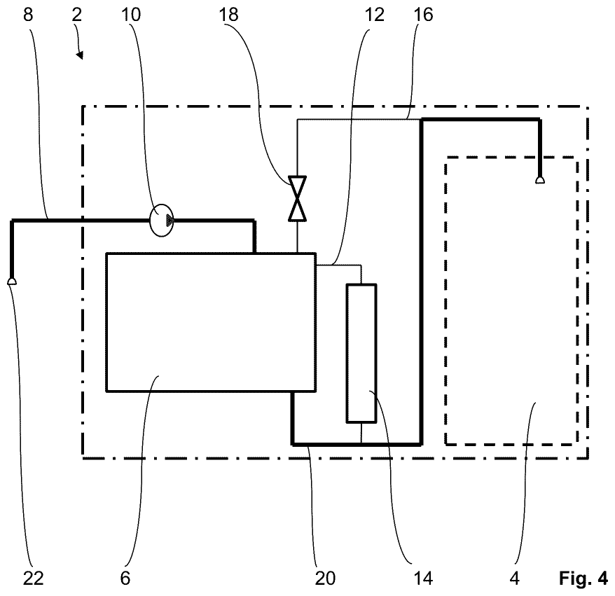

Subsequently, in a third method step, the tank 6 is filled with fresh water by means of the filling pipe 8 and the pump 10, with the shut-off valve 18 closed and the steam generator 14 switched off, until the cleaning acid has been displaced into the cooking chamber 4 by means of the fresh water in the bypass pipe 20 fluidically connected to the steam generator 14 and the overflow pipe 16. For this, see FIG. 4. The fresh water is tap water, which, analogously to the cleaning acid, can be introduced into the steaming system 2 by means of a container filled therewith and by means of the filler neck 22.

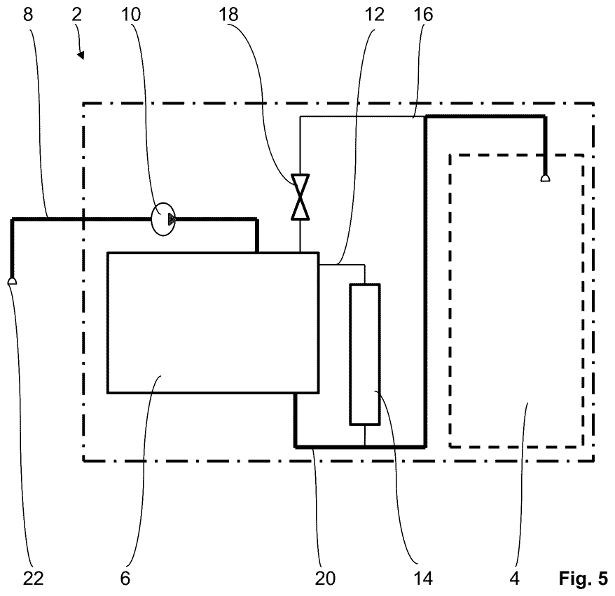

FIG. 5 shows a fourth method step in which the tank 6 is filled with air by means of the filling pipe 8 and the pump 10, with the shut-off valve 18 closed, until the fresh water has been displaced into the cooking chamber 4 by means of the bypass pipe 20. The air is ambient air, which can be introduced into the steaming system 2 via the filler neck 22.

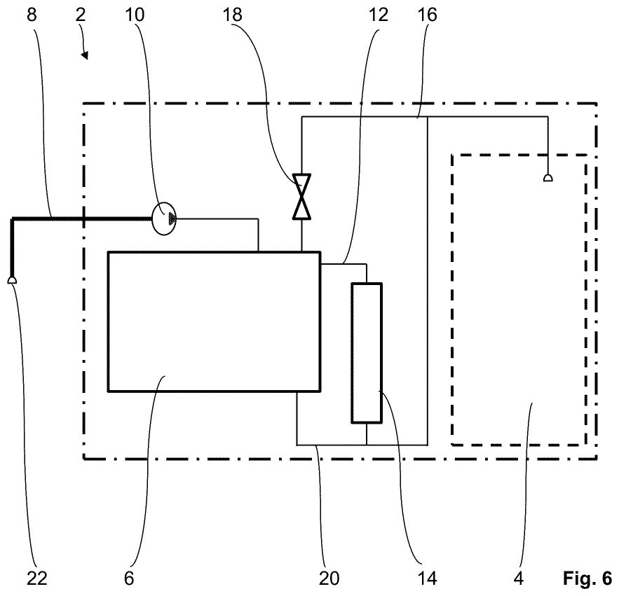

In a fifth method step, the pump 10 is wetted with a predetermined amount of fresh water by means of the filling pipe 8 and the pump 10, the amount of fresh water being designed only to wet the pump 10. This predetermined amount of fresh water for wetting the pump 10 is only 30 ml here. For this, see FIG. 6. Wetting the pump 10 with fresh water takes place analogously to the third method step.

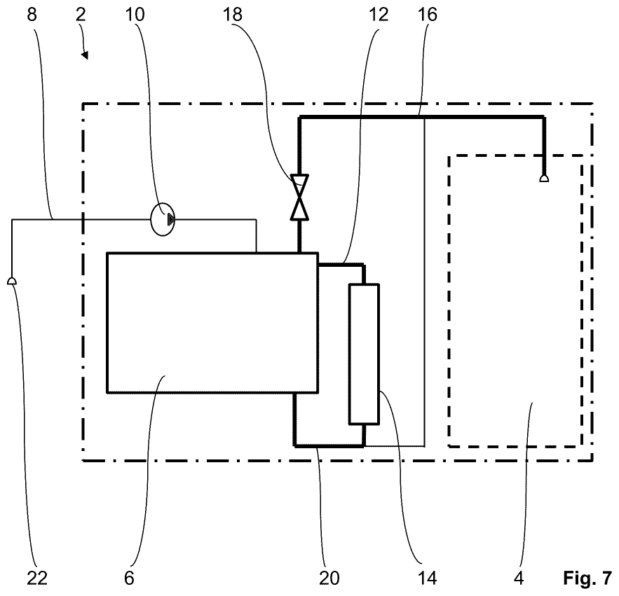

Finally, in a sixth method step, an amount of residual water that is downstream of the pump 10 in the steaming system 2 is evaporated by means of the steam generator 14, with the shut-off valve 18 open. For this, see FIG. 7.

Due to the design of the method, the steaming system 2 and the cooking appliance according to the invention, cleaning the steaming system 2 is significantly improved in a very simple manner in terms of construction, manufacturing technology and circuitry. Furthermore, the steaming system 2 can be operated reliably by means of the implemented method even over a long service life of the cooking appliance. This applies in particular to structurally small steaming systems, as is the case with the present steaming system 2. Furthermore, it is achieved that an additional pump for pumping out the saturated cleaning acid and an additional drain into the cooking chamber 4 for discharging the saturated cleaning acid from the steaming system 2 can be omitted compared to the prior art. In addition, the life, i.e. the total operating period, of the individual components of the steaming system 2 is significantly extended compared to conventional systems and cooking appliances equipped therewith. This is because, on the one hand, the only pump 10 of the steaming system 2 exclusively conveys pure cleaning acid, i.e. cleaning acid without solid particles, pure fresh water and pure air, and, on the other hand, the only shut-off valve 18 is only activated for a short time after prior wetting with liquid.

The invention is, however, not limited to the present embodiment. See, for example, the explanations in this regard in the introduction to the description.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for cleaning a steaming system of a cooking appliance having a cooking chamber, the method comprising, in order:
filling a tank of the steaming system with a cleaning acid by a filling pipe and a pump of the steaming system until the cleaning acid overflows from the tank into the cooking chamber by an overflow pipe of the steaming system, which overflow pipe comprises a shut-off valve;
circulating the cleaning acid from the tank into a steam generator of the steaming system and back;
filling the tank with fresh water by the filling pipe and the pump, with the shut-off valve closed and the steam generator switched off, until the cleaning acid is displaced into the cooking chamber by the fresh water in a bypass pipe fluidically connected to the steam generator and the overflow pipe;
filling the tank with air by the filling pipe and the pump, with the shut-off valve closed, until the fresh water is displaced into the cooking chamber by the bypass pipe;
wetting the pump with a predetermined amount of fresh water by the filling pipe and the pump, the predetermined amount of fresh water being designed only to wet the pump; and
evaporating an amount of residual water downstream of the pump in the steaming system by the steam generator, with the shut-off valve open.

2. The method of claim 1, wherein:
the cleaning acid comprises citric acid, and/or
the fresh water comprises tap water, and/or
the air is ambient air.

3. The method of claim 1, wherein circulation of the cleaning acid takes place only by the steam generator.

4. The method of claim 1, wherein the predetermined amount of fresh water for wetting the pump is less than or equal to 50 ml.

5. A streaming system for a cooking appliance, comprising:
a cooking chamber,
wherein the steaming system is configured to carry out the method of claim 1.

6. The steaming system of claim 5, wherein the steaming system comprises the following components in a specified arrangement:
a tank,
a filling pipe fluidically connected to the tank, which filling pipe comprises a pump configured to fill the tank with a fluid,
a steam generator fluidically connected to the tank by a connecting pipe,
an overflow pipe comprising a shut-off valve configured to fluidically connect the tank to the cooking chamber, and
a bypass pipe fluidically connected to the tank, the steam generator and the overflow pipe, which bypass pipe is configured to fluidically connect to the cooking chamber of the cooking appliance.

7. The steaming system of claim 6, wherein:
the filling pipe comprising the pump is fluidically connected to the tank on an upper side of the tank, and/or
the steam generator is fluidically connected to the tank, at one end at a position on one side of the tank directly adjacent to the upper side, and at an other end on a lower side of the tank, and/or
the overflow pipe is fluidically connected to the tank on an upper side of the tank, and/or
the bypass pipe is fluidically connected to the tank on a lower side of the tank.

8. The steaming system of claim 6, wherein the shut-off valve comprises a pinch valve.

9. A cooking appliance, comprising:
a cooking chamber; and
the steaming system of claim 5 being configured to steam the cooking chamber with steam.

10. The method of claim 3, wherein the steam generator is operated in short heating pulses such that a thermal circulation of the cleaning acid takes place.

11. The method of claim 4, wherein the predetermined amount of fresh water for wetting the pump is less than or equal to 40 ml.

12. The method of claim 11, wherein the predetermined amount of fresh water for wetting the pump is less than or equal to 30 ml.
